(19) United States
(12) Patent Application Publication
(10) Pub. No.: US 2013/0027618 A1
(43) Pub. Date: Jan. 31, 2013

(54) SUPPORT FOR HOLDING MUTIPLE DISPLAYS AND DISPLAY DEVICE WITH SAME

(71) Applicant: QIANG CHEN, Shenzhen City (CN)

(72) Inventor: QIANG CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/248,043

(22) Filed: Sep. 29, 2011

(30) Foreign Application Priority Data
Jul. 26, 2011 (CN) 201110210535.8

(51) Int. Cl. H04N 5/64

(52) U.S. Cl. 348/836; 348/E05.128

(57) ABSTRACT

A support for supporting display panels includes a base, a column on the base, a number of brackets, and a number of connecting units. The base includes a number of video signal connector units and an electrical power connector unit for inputting electrical power, an MCU connected to the video signal connector units and controlling the input of the video signal connector units and the output of the display panels; and an electrical distribution unit connected to the electrical power connector unit and distributing electrical power from the electrical power connector unit to the MCU and the display panels. Each bracket secures a corresponding display panel to the column. Each connecting unit connects the MCU and the electrical power distribution unit to a corresponding display panel.

### BACKGROUND

1. Technical Field

The present disclosure relates to a support capable of holding multiple displays and a display device.

2. Description of Related Art

A display device typically includes a display panel and a support steadily supporting the display panel on a table or other objects.

Many display panels and supports have an one-to-one matching. Thus, if more than one display panel is needed, the same number of corresponding supports is needed as well, which will undesiredly occupy a lot of space.

What is needed therefore is a support and a display device addressing the limitations described.

### BRIEF DESCRIPTION OF THE DRAWINGS

The components of the drawings are not necessarily drawn to scale, the emphasis instead being placed upon clearly illustrating the principles of the embodiments of the support and display device having the support. Moreover, in the drawings, like reference numerals designate corresponding parts throughout several views.

FIG. 1 is a schematic view of a display device, according to an exemplary embodiment of the present disclosure, the display device including a connector.

FIG. 2 is a schematic view of the connector of the display device of FIG. 1.

### DETAILED DESCRIPTION

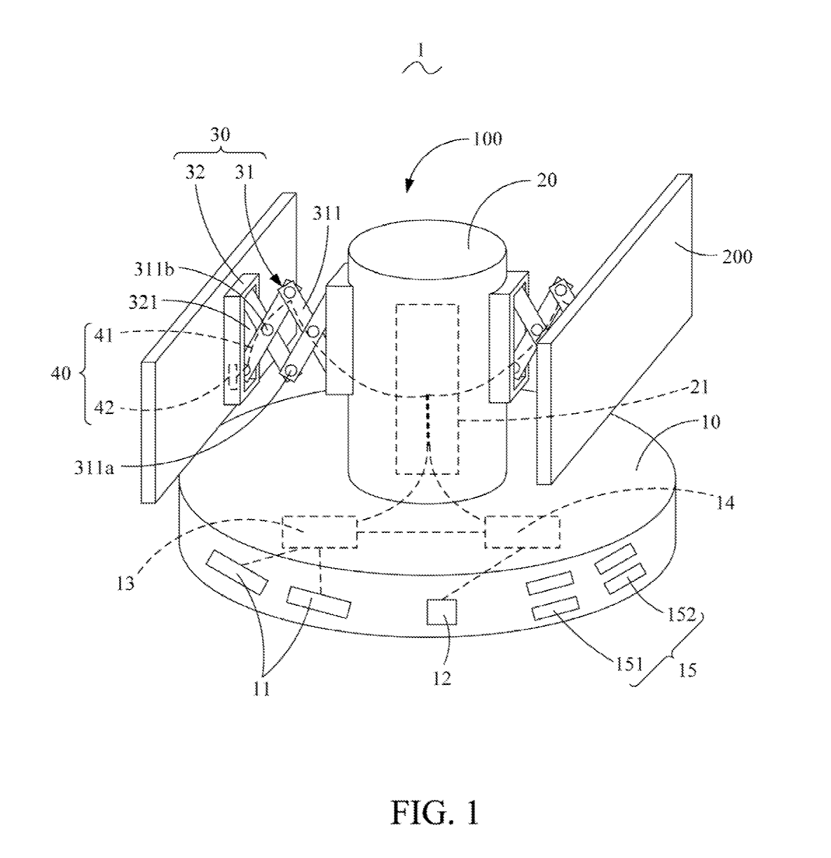

Referring to FIG. 1, a display device 1, according to an exemplary embodiment, is shown. The display device 1 includes a support 100 and a number of display panels 200 supported on the support 100. The support 100 includes a base 10, a column 20 connected to the base 10, a number of brackets 30 connected to the column 20, and a number of connecting units 40. The number of the brackets 30 corresponds to that of the display panels 200, and each bracket 30 supports a corresponding display panel 200.

The base 10 is substantially a flat cylinder. The base 10 includes a number of video signal connector units 11, an electrical power connector unit 12, a master control unit (MCU) 13 and an electrical power distribution unit 14. The number of the video signal connector unit 11 is the same as that of the brackets 30. A connecting end of each video signal connector unit 11 is exposed out of a surface of the base 10, for connecting to a video signal output end of a host (not shown). In this embodiment, the connecting end of each video signal connector unit 11 is exposed out of a side surface of the base 10. The video signal connector units 11 can be video graphic array (VGA) connector, digital visual interface (DVI) connector or high definition multimedia (HDMI) connector. A connecting end of the electrical power connector unit 12 is exposed out of a surface of the base 10, for connecting to an external electrical power source (not shown). The MCU 13 is disposed in the base 10 and connected to the video signal connector units 11. The MCU 13 controls the input/output of video signals. In detail, the MCU 13 controls the input of the video signal connector units 11 and the output of the display panels 200. For example, (1) the MCU 13 controls each of the video signal connector units 11 to input video signals to a corresponding display panel 200, and controls the display panels 200 to output video signals from a corresponding video signal connector unit 11; (2) the MCU 13 controls one of the video signal connector units 11 to input video to more than one display panels 200, and controls the more than one display panels 200 to simultaneously output video signals from the video signal connector unit 11; (3) the MCU 13 controls the video signal connector units 11 to input video signals to one of the display panels 100, and controls the display panel 200 to selectively output the video signals of the video signal connector units 11, in this case, the display panel 200 selectively outputs the video signals of the video signal connector unit 11 through a switching key (not shown), the switching key can be disposed on a side edge of the display panel 200. The electrical power connector unit 12 is electrically connected to the electrical power distribution unit 14, for supplying electrical power to the display panels 200 and the MCU 13.

The base 10 further includes an universal serial bus (USB) connector unit 15. The USB connector unit 15 includes a number of first USB connectors 151 and two second USB connectors 152. Each first USB connectors 151 is connected to a corresponding host. One of the second USB connectors 152 is connected to a keyboard (not shown), and the other of the second USB connector 152 is connected to a mouse (not shown). A keyboard, video and mouse (KVM) switch (not shown) is disposed between the first USB connectors 151 and the second USB connectors 152, the first USB connectors 151 and the second USB connectors 152 are respectively connected to the KVM switch. Thus, a user can control multiple hosts via a keyboard and a mouse.

The column 20 can be cylinder-shaped or prism-shaped. In this embodiment, the column 20 is cylinder-shaped. The column 20 supports the brackets 30. The column 20 defines a cable duct 21 therein.

The brackets 30 are extendible and retractable relative to the column 20. Each bracket 30 includes an extending portion 31 and two connecting blocks 32 respectively connected to opposite ends of the extending portion 31. Each extending portion 31 includes a number of hinged bars 311. Each hinged bar 311 defines two first through holes 311a in opposite ends and a second through hole 311b between the first through holes 311a. Two hinged bars 311 are hinged to each other by inserting a shaft (not show) in the second through holes 311b, thus the two hinged bars 311 form a hinged unit. The extending portion 31 includes at least one hinged unit. In this embodiment, each extending portion 31 includes two hinged units. The first through holes 311a of the hinged bars 311 at a side of a hinged unit are respectively aligned with the first through holes 311a of the hinged bars 311 of another hinged unit. Two shafts (not shown) are respectively inserted into the aligned first through holes 311a, thus the two hinged unit are hinged to each other by the shafts. In this embodiment, each hinged bar 311 is hollow for allowing cables to pass therethrough.

Each connecting block 32 defines a mounting slot 321 therein. Distal ends of the hinged bars 311 at opposite ends of the extending portion 31 are respectively mounted into the mounting slots 321 of the connecting blocks 32. Furthermore, the distal ends of the hinged bars 311 are movable along the mounting slots 321. A length of the extending portion 31 can be adjusted by compressing or dragging the connecting blocks 32 relative to each other. One of the connecting blocks 32 is fixedly connected to the column 20, and the other of the connecting blocks 32 is fixedly connected to a corresponding display panel 200.

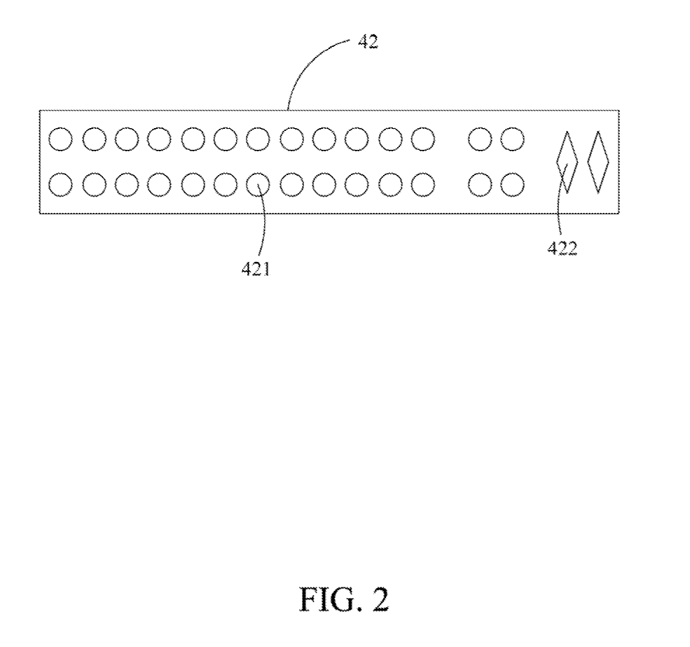

The number of the connecting units 40 are corresponding to that of the display panels 200. Each connecting unit 40 connects a corresponding display panel 200 to the MCU 13 and the electrical power distribution unit 14. Each connecting unit 40 includes a cable 41 and a connector 42. The cable 41 passes through the cable duct 21 of the column 20 and the two hinged bars 311 of a corresponding extending portion 31. One end of the cable 41 is divided into two bunches, a bunch of cable 41 is electrically connected to the MCU 13, and the other bunch of the cable 41 is electrically connected to the electrical power distribution unit 14. Another end of the cable 41 is electrically connected to the connector 42. The connector 42 is disposed on a mounting block 32 of a corresponding bracket 30 away from the column 20. Referring to FIG. 2, each connector 42 includes a number of signal pins 421 and two electrical power pins 422. The signal pins 421 transmit video signals from the MCU 13 into a corresponding display panel 200, and the power pins 422 transmit electrical power from the electrical power distribution unit 14 into a corresponding display panel 200. In this embodiment, the signal pins 421 are arranged into two substantially parallel rows, and a cross section of each signal pin 421 is substantially circular-shaped. The electrical power pins 422 are disposed at an end of the rows of the signal pins 421. A cross section of each electrical power pin 422 is substantially rhombus-shaped. Structured as such, both video signals and electrical power can transmit to a display panel 200 via a cable 41 and a connector 42, thus a connection between the display panel and the MCU 13 and the electrical power distribution unit 14 is simplified.

Each display panel 200 is connected to a mounting block 32 of a corresponding bracket 30 away from the column 20. In detail, the display panel 200 can be connected to the mounting block 32 via a number of bolts (not shown). Each display panel 200 includes a display connector (not shown) capable of coupling with the connector 42 of a corresponding connecting unit 40. In this embodiment, the connectors 42 are male connectors, the display connectors are female connectors.

In use, each video signal connector unit 11 is connected to a corresponding host (not shown), the electrical power connector unit 12 is connected to an external electrical power source (not shown). The electrical power of the external power source transmits to the electrical power distribution unit 14 through the electrical power connector unit 12, then distributed to the connecting units 40 by the electrical power distribution unit 14, and finally, transmits to the display panels 200 through the corresponding connecting units 40. Video signals from hosts transmit to the MCU 13 through the corresponding video signal connector units 11, then the video signals are transmitted to a predetermined display panel(s) 200 under the control of the MCU 13. For example, (1) the MCU 13 controls each of the video signal connector units 11 to input video signals to a corresponding display panel 200, and controls the display panels 200 to output video signals from a corresponding video signal connector unit 11; (2) the MCU 13 controls one of the video signal connector units 11 to input video to more than one display panels 200, and controls the more than one display panels 200 to simultaneously output video signals from the video signal connector unit 11; (3) the MCU 13 controls the video signal connector units 11 to input video signals to one of the display panels 100, and controls the display panel 200 to selectively output the video signals through the video signal connector units 11. In this embodiment, the number of the display panels 200 is two, and the same as the brackets 30, the video signal connector units 11 and the first USB connectors 151. The display panels 200, the brackets 30, the video signal connector units 11 and the first USB connectors 151 are respectively corresponding to two hosts. In other embodiments, the number of the display panels 200, the brackets 30, the video signal connector units 11 and the first USB connectors 151 can be changed according to different number of hosts.

As such structured, a number of the display panels 200 can be supported on a support 100, therefore, a space occupied by the display device 1 is reduced.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A support for supporting a plurality of display panels, comprising:
a base comprising
a plurality of video signal connector units;
an electrical power connector unit for inputting electrical power of an external power source;
an MCU electrically connected to the video signal connector units for controlling the input of the video signal connector units and the output of the display panels; and
an electrical distribution unit electrically connected to the electrical power connector unit and the MCU, the electrical distribution unit being configured for distributing electrical power from the electrical power connector unit to the MCU and the display panels;
a column positioned on the base;
a plurality of brackets connected to the column, each bracket being configured for securing a corresponding display panel to the column; and
a plurality of connecting units, each connecting unit connecting the MCU and the electrical power distribution unit, each connecting unit being configured to electrically communicate the MCU and the electrical power distribution unit with a corresponding display panel.

2. The support of claim 1, wherein the video signal connector units are selected from a group consisting of VGA connector, DVI connector and HDMI connector.

3. The support of claim 1, wherein the MCU is configured to control each of the video signal connector units to input video signals to a corresponding display panel, and control each display panel to output video signals through a corresponding video signal connector unit.

4. The support of claim 1, wherein the MCU is configured to control one of the video signal connector units to input video signals to more than one display panels, and control the more than one display panels to output video signals through the one of the connector units.

5. The support of claim 1, wherein the MCU is configured to control the video signal connector units to input video signals to one of the display panels, and control the one of the display panels to selectively output the video signals through the video signal connector units

6. The support of claim 1, wherein the base comprises a USB unit.

7. The support of claim 6, wherein the USB connector unit comprises a number of first USB connectors and two second USB connectors, each first USB connectors is configured for being connected to a corresponding host, one of the second USB connectors is configured for being connected to a keyboard, and the other of the second USB connector is configured for being connected to a mouse.

8. The support of claim 1, wherein each bracket comprises an extending portion and two connecting blocks respectively connected to opposite ends of the extending portion, one of the connecting blocks is fixedly connected to the column, and the other of the connecting blocks is configured to be fixedly connected to a corresponding display panel.

9. The support of claim 8, wherein each extending portion comprises at least a pair of hinged bars hinged to each other, each hinged bar defines two first through holes in opposite ends thereof and a second through hole between the first through holes, the second through holes of the hinged bars are aligned with each other.

10. The support of claim 9, wherein each hinged bar is hollow.

11. The support of claim 9, wherein each connecting block defines a mounting slot therein, distal ends of the hinged bars at two opposite ends of the extending portion are respectively mounted into the mounting slots of the connecting blocks and movable along the mounting slots.

12. The support of claim 1, wherein each connecting unit comprises a cable and a connector, the cable electrically connects the MCU and the electrical power distribution unit to the connector, the connector is configured to be connected to a corresponding display panel.

13. The support of claim 12, wherein the connector is positioned on a corresponding bracket away from the column.

14. The support of claim 12, wherein the connector comprises a number of signal pins and two electrical power pins, the signal pins are configure for transmitting video signals from the MCU, and the power pins are configured for transmitting electrical power from the electrical power distribution unit.

15. The support of claim 14, wherein a cross section of each electrical power pin is substantially rhombus-shaped.

16. The support of claim 12, wherein the column defines a cable duct therein for allowing the cable to pass therethrough.

17. A display device, comprising:
a plurality of the display panels; and
a support supporting the display panels, comprising:
a base comprising:
a plurality of video signal connector units;
an electrical power connector unit for inputting electrical power of an external power source;
an MCU electrically connected to the video signal connector units for controlling the input of the video signal connector units and the output of the display panels; and
an electrical distribution unit electrically connected to the electrical power connector unit, the MCU, and the display panels, the electrical distribution unit being configured for distributing electrical power from the electrical power connector unit to the MCU and the display panels,
a column positioned on the base;
a plurality of brackets connected to the column, each bracket securing a corresponding display panel to the column; and
a plurality of connecting units, each connecting unit connecting the MCU and the electrical power distribution unit to a corresponding display panel.
